(19) United States
(12) Patent Application Publication
(10) Pub. No.: US 2022/0301359 A1
(43) Pub. Date: Sep. 22, 2022

(54) VEHICLE MANAGEMENT APPARATUS, VEHICLE MANAGEMENT METHOD, AND COMPUTER READABLE RECORDING MEDIUM

(71) Applicant: HONDA MOTOR CO.,LTD., Tokyo (JP)

(72) Inventors: Yasuhito TAKEI, Saitama (JP); Atsushi FUJIKAWA, Saitama (JP); Tsutomu KAMIYAMAGUCHI, Saitama (JP); Fumihiro YOSHINO, Saitama (JP); Hiroshi KIMURA, Saitama (JP); Ryosuke ITOYAMA, Saitama (JP); Ryuzo SAKAMOTO, Saitama (JP); Atsushi KUBOTA, Saitama (JP)

(21) Appl. No.: 17/676,851

(22) Filed: Feb. 22, 2022

(30) Foreign Application Priority Data
Mar. 19, 2021 (JP) 2021-046468

(51) Int. Cl. G07C 5/00; G07C 5/08; G06Q 10/00; G06Q 10/08; G06N 20/10

(52) U.S. Cl. CPC G07C 5/006; G07C 5/0808; G07C 5/008; G06Q 10/20; G06Q 10/087; G06N 20/10

(57) ABSTRACT

A vehicle management apparatus may include a collection unit configured to collect data indicating a state of a vehicle based on a detection result of a sensor configured to detect the state of the vehicle from a plurality of vehicles. The vehicle management apparatus may include a classification unit configured to classify the plurality of vehicles into a plurality of group according to a predetermined algorithm based on the data of each of the plurality of vehicles. The vehicle management apparatus may include an identification unit configured to identify, when a faulty vehicle in which a failure has occurred is present among the plurality of vehicles, another vehicle belonging to a group to which the faulty vehicle belongs from among a plurality of groups as a failure symptom vehicle having a symptom of occurrence of a failure.

### BACKGROUND

### 1. Technical Field

The contents of the following Japanese patent application(s) are incorporated herein by reference:

NO. 2021-046468 filed in JP on Mar. 19, 2021

The present invention relates to a vehicle management apparatus, a vehicle management method, and a computer readable recording medium.

### 2. Related Art

Patent document 1 describes a failure symptom detection apparatus configured to compare a sensor value of a sensor mounted to a vehicle with a normal threshold, and determine whether an abnormality occurs in the sensor based on this comparison result.

### PRIOR ART DOCUMENT

### Patent Documents

[Patent document 1] Japanese Unexamined Patent Application, Publication No. 2011-230634

### BRIEF DESCRIPTION OF THE DRAWINGS

FIG. 1 illustrates one example of an overall configuration of a vehicle management system.

FIG. 2 schematically illustrates a system configuration of a control system included in a vehicle.

FIG. 3 illustrates one example of data acquired from a sensor.

FIG. 4 illustrates one example of a numeric vector.

FIG. 5 illustrates a functional block of a vehicle management server.

FIG. 6 is a diagram for describing clustering of data.

FIG. 7 illustrates one example of a core vector.

FIG. 8 is a flowchart illustrating one example of a failure symptom sensing procedure.

FIG. 9 is a flowchart illustrating one example of an operation procedure of the vehicle when an ignition switch is turned on.

FIG. 10 illustrates one example of a hardware configuration.

### DESCRIPTION OF EXEMPLARY EMBODIMENTS

Hereinafter, the present invention will be described by way of embodiments of the invention, but the following embodiments are not intended to restrict the invention according to the claims. In addition, not all combinations of features described in the embodiments necessarily have to be essential to solving means of the invention.

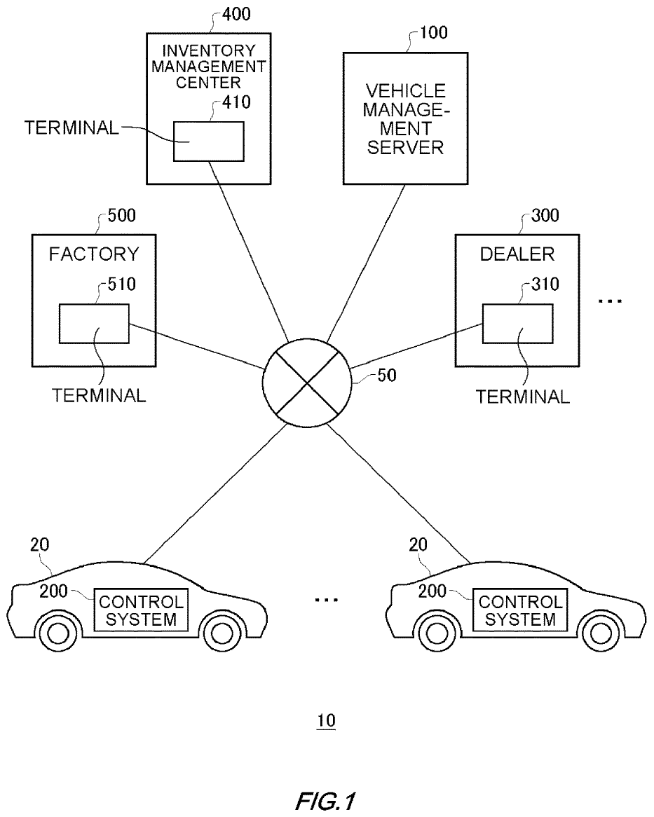

FIG. 1 illustrates one example of an overall configuration of a vehicle management system 10 according to the present embodiment. The vehicle management system 10 includes a plurality of vehicles 20 and a vehicle management server 100. The vehicle management system 10 further includes a terminal 310 arranged in each of a plurality of dealers 300, a terminal 410 arranged in an inventory management center 400, and a terminal 510 arranged in a factory 500.

The vehicle 20, the vehicle management server 100, and the terminals 310, 410, and 510 may be connected to each other via a network 50 such as the Internet.

The vehicle 20 includes a control system 200 configured to control the vehicle 20. According to the present embodiment, an example will be described while a hybrid vehicle is used as the vehicle 20. However, the vehicle 20 may be a vehicle of any driving method such as an engine vehicle or an electric motor vehicle.

Inventory management in the dealer 300, order placement of a new vehicle, order placement of a repair part, and the like are performed in the dealer 300 via the terminal 310. Aggregation of order placements of the new vehicles from the respective dealers 300 and an order placement for a vehicle fabrication factory, aggregation of the parts from the respective dealers 300 and an order placement for a part factory, inventory management of the parts in the inventory management center 400, and the like are performed in the inventory management center 400 via the terminal 410. In response to the order placement from the inventory management center 400 via the terminal 510, fabrication of the vehicles, fabrication of the part, or the like are performed in the factory 500. It should be noted that the fabrication of the vehicles and the fabrication of the parts may be respectively performed in the different factories 500.

The vehicle management server 100 is configured to manage the plurality of vehicles 20. The vehicle management server 100 aggregates information of failures of the plurality of vehicles 20, and identifies the vehicle 20 in which a similar failure may occur as a failure symptom vehicle. Then, the vehicle management server 100 places an order of the vehicle or the part as necessary before a user of the failure symptom vehicle visits the dealer 300 for replacement of the part, purchase of the new vehicle, or the like. With this configuration, the replacement of the part or a delivery period of the new vehicle can be shortened.

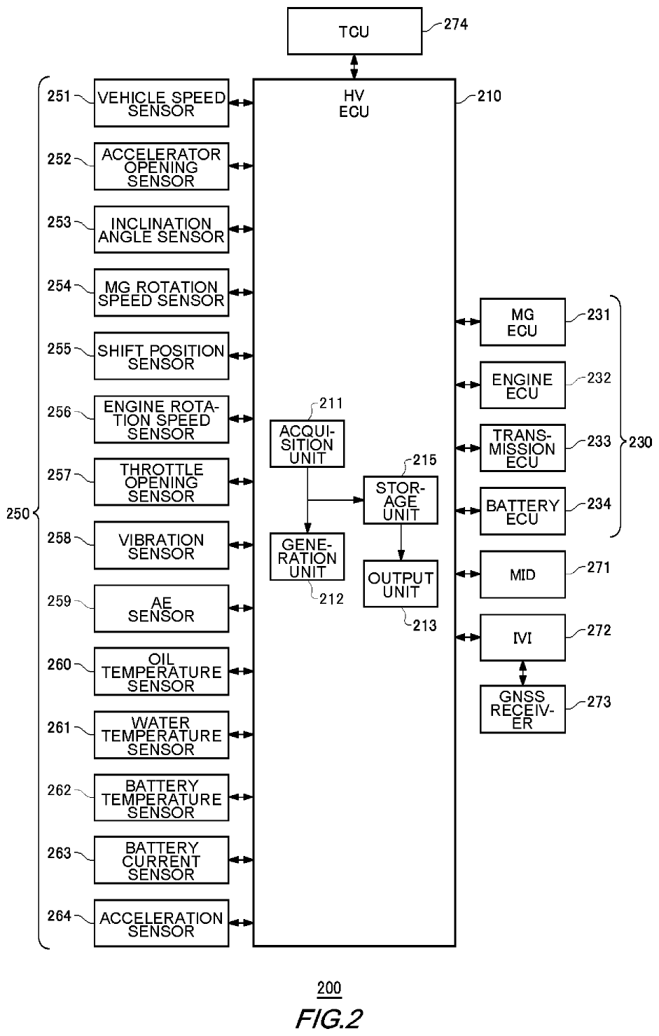

FIG. 2 schematically illustrates a system configuration of the control system 200 included in the vehicle 20. The control system 200 includes an HVECU 210, various types of ECUs 230, various types of sensors 250, an MID 271, an IVI 272, a GNSS receiver 273, and a TCU 274.

The HVECU 210 is a hybrid electronic control unit (ECU) configured to control the vehicle 20. The HVECU 210 and the various types of ECUs 230 may be configured by including a so called microcomputer constituted by a CPU, a ROM, a RAM, an input and output interface, and the like. The HVECU 210 performs signal processing according to a program stored in advance in the ROM while a temporary storage function of the RAM is utilized.

The HVECU 210 is connected to the MID 271, the IVI 272, the TCU 274, and each of the ECUs 230 via an in-vehicle communication line. The HVECU 210 communicates with the MID 271, the IVI 272, the TCU 274, and the various types of ECUs 230 via the in-vehicle communication line. The HVECU 210 controls the MID 271, the IVI 272, the TCU 274, and each of the ECUs 230 in an overall manner via the in-vehicle communication line. The in-vehicle communication line may be configured by including, for example, a controller area network (CAN), an Ether network, or the like.

The MID 271 is a multi information display. The IVI 272 is an in-vehicle infotainment information device (IVI). The MID 271 and the IVI 272 are connected to the HVECU 210 via the in-vehicle communication line. The MID 271 and the IVI 272 may function as a display control unit. The IVI 272 includes a wireless LAN communication function. The GNSS receiver 273 identifies a location of the vehicle 20 based on a signal received from a global navigation satellite system (GNSS) satellite.

The IVI 272 acquires location information of the vehicle 20 from the GNSS receiver 273. The IVI 272 outputs the location information acquired from the GNSS receiver 273 to the HVECU 210.

The TCU 274 is a telematics control unit. The TCU 274 is mainly responsible for a mobile communication. The TCU 274 transmits and receives data with an external apparatus based on the control of the HVECU 210.

Each of the ECUs 230 includes an MGECU 231, an engine ECU 232, a transmission ECU 233, and a battery ECU 234. The MGECU 231 controls a driving motor generator mounted to the vehicle 20. The engine ECU 232 controls an engine mounted to the vehicle 20. The transmission ECU 233 controls a transmission mounted to the vehicle 20. The battery ECU 234 controls a battery that is a high voltage battery mounted to the vehicle 20.

The HVECU 210 executes hybrid drive control related to the motor generator via the MGECU 231 and the engine via the engine ECU 232. The HVECU 210 executes shift control of the transmission via the transmission ECU 233. The HVECU 210 executes charge and discharge control of the battery via the battery ECU 234.

The various types of sensors 250 include a vehicle speed sensor 251, an accelerator opening sensor 252, an inclination angle sensor 253, an MG rotation speed sensor 254, a shift position sensor 255, an engine rotation speed sensor 256, a throttle opening sensor 257, a vibration sensor 258, an AE sensor 259, an oil temperature sensor 260, a water temperature sensor 261, a battery temperature sensor 262, a battery current sensor 263, and an acceleration sensor 264. The various types of sensors 250 may include other sensors configured to detect a torque of the engine or the motor generator, a current of the motor generator, a temperature of the motor generator, a hydraulic pressure of engine oil, a temperature of hydraulic oil of an automatic transmission (ATF temperature), a sound, and the like.

The vehicle speed sensor 251 detects a vehicle speed of the vehicle 20. The accelerator opening sensor 252 detects an accelerator opening based on an operation of a driver, that is, an operation amount of an accelerator pedal. The inclination angle sensor 253 detects an inclination of the vehicle 20. The MG rotation speed sensor 254 detects a rotation speed of the motor generator. The shift position sensor 255 detects a shift position of a shift lever. The engine rotation speed sensor 256 detects a rotation speed of the engine. The throttle opening sensor 257 detects an opening of a throttle value of the engine. The battery temperature sensor 262 detects a temperature of the battery. The battery current sensor 263 detects a charge and discharge current of the battery.

The HVECU 210 sets required driving force based on the vehicle speed detected by the vehicle speed sensor 251 and the accelerator opening detected by the accelerator opening sensor 252. The HVECU 210 judges whether the vehicle 20 is at the start of travelling based on the vehicle speed detected by the vehicle speed sensor 251. The HVECU 210 judges whether the vehicle 20 is on an uphill road or a downhill road based on the inclination angle detected by the inclination angle sensor 253. The engine ECU 232 controls an output torque from the engine according to the set required driving force based on an instruction from the HVECU 210. The MGECU 231 controls an output torque from the motor generator according to the set required driving force based on an instruction from the HVECU 210. The transmission ECU 233 performs shift control of the transmission according to the set required driving force.

The battery ECU 234 controls charge and discharge of the battery based on battery information indicating a state of the battery such as an inter-terminal voltage of the battery, the charge and discharge current of the battery from the battery current sensor 263, and the battery temperature from the battery temperature sensor 262. The battery ECU 234 executes an arithmetic operation of a state of charge (SOC) based on an integrated value of charge and discharge currents of the battery.

The vibration sensor 258 senses vibration of any portion of the vehicle 20 where it is possible to sense a symptom of a failure of the vehicle 20 such as, for example, a vibration of the vehicle 20, vibration of the engine, a vibration of the transmission, or a vibration of a suspension. The AE sensor 259 is an acoustic emission sensor. The AE sensor 259 is a sensor configure to detect ultrasonic wave and acoustic wave energy that is generated along with a phenomenon such as a deformation of an object, a progress of a crack, or peeling. The AE sensor 259 may be provided at any portion of the vehicle 20 such as the engine where it is possible to sense the symptom of the failure of the vehicle 20. The oil temperature sensor 260 detects, for example, a temperature of the engine oil (oil temperature). The water temperature sensor 261 detects, for example, a temperature of cooling water flowing in a water jacket that is a cooling water channel formed in a cylinder head and a cylinder. The acceleration sensor 264 detects an acceleration of the vehicle 20 to determine whether the vehicle 20 is in an acceleration state, a deceleration state, or a constant speed state (cruise state).

The vehicle management server 100 aggregates data indicating the states of the vehicles 20 from the various types of sensors 250 of the plurality of vehicles 20. The vehicle management server 100 identifies the vehicle 20 exhibiting a same behavior as the faulty vehicle 20 as the failure symptom vehicle based on the aggregated data indicating the states of the vehicles 20, and notifies a user of the failure symptom vehicle or the dealer 300 where the failure symptom vehicle is managed of that effect.

According to the present embodiment, the HVECU 210 of the vehicle 20 generates data indicating the state of the vehicle 20 based on the detection results from the various types of the sensors 250, and provides the data to the vehicle management server 100.

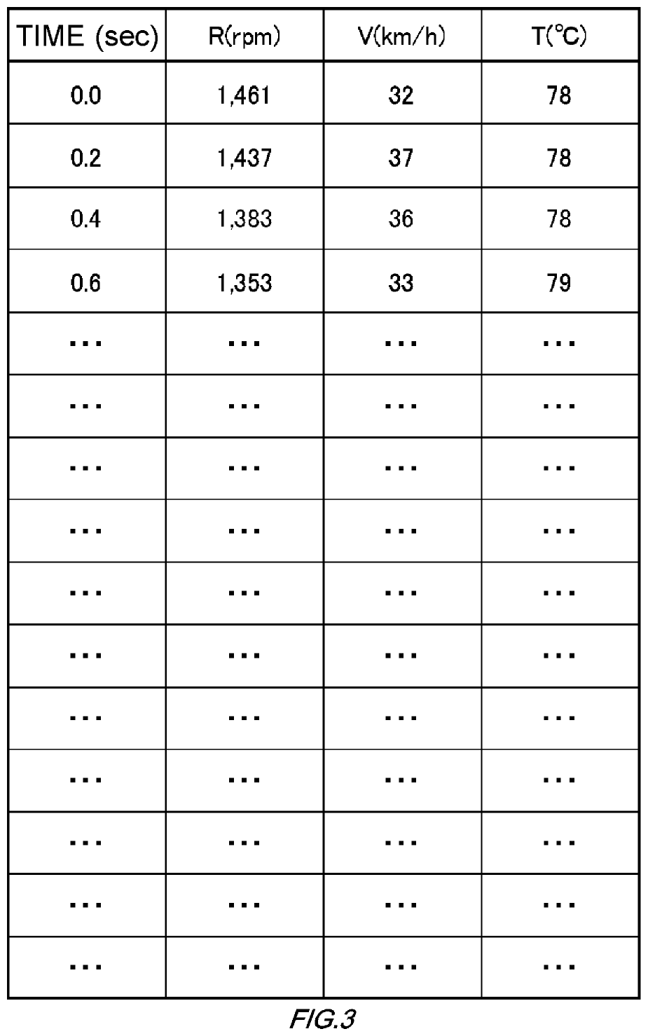

The HVECU 210 includes an acquisition unit 211, a generation unit 212, an output unit 213, and a storage unit 215. The acquisition unit 211 acquires a plurality of pieces of data from a plurality of sensor 250 configured to sense a state of the vehicle 20. The acquisition unit 211 may acquire a plurality of pieces of data from the plurality of sensors 250 configured to sense the state of the vehicle 20 for every predetermined period of time during a state in which the vehicle 20 can travel. For example, as illustrated in FIG. 3, the acquisition unit 211 acquires, as the plurality of pieces of data, an engine rotation speed (R) from the engine rotation speed sensor 256, a vehicle speed (V) of the vehicle 20 from the vehicle speed sensor 251, and a cooling water temperature (T) indicating a temperature of cooling water of the engine from the water temperature sensor 261 at an interval of 0.2 seconds, and stores the data in the storage unit 215.

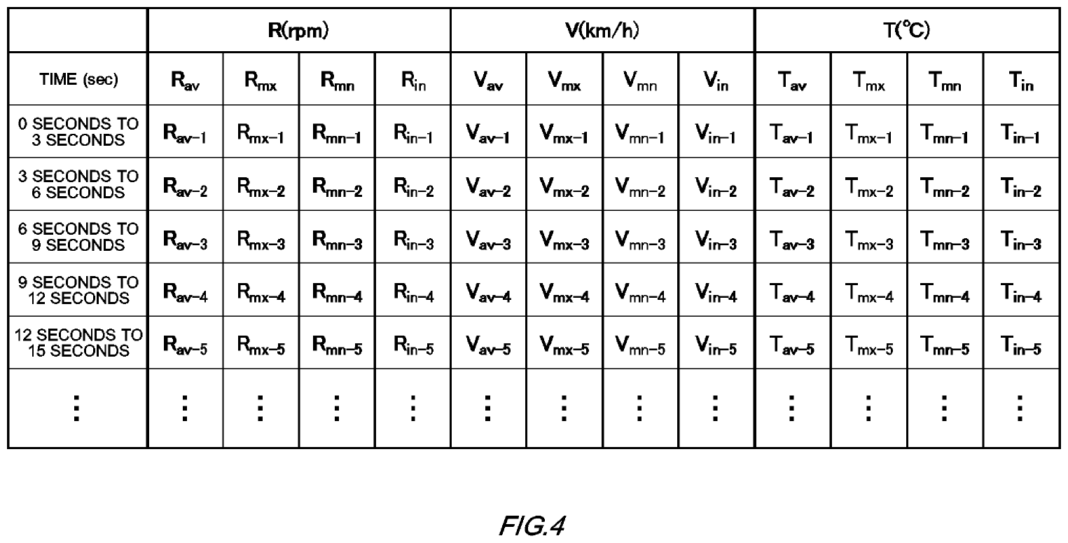

The generation unit 212 generates feature amount data indicating a feature amount of each of the plurality of pieces of data according to a predetermined algorithm from the plurality of pieces of data acquired by the acquisition unit 211, and stores the feature amount data in the storage unit 215. The generation unit 212 may generate a numeric vector that is the feature amount data indicating the feature amount of each of the plurality of pieces of data. The generation unit 212 may generate the numeric vector of each of the plurality of pieces of data by calculating average values, maximum values, minimum values, and average values of the inclinations of the data at every predetermined time slot (for example, every 3 seconds). As illustrated in FIG. 4, the generation unit 212 may calculate, with regard to the engine rotation speed (R) at every 3 seconds, an average value (Rₐᵥ), a maximum value (Rₘₓ), a minimum value (Rₘₙ), and an average value of the inclinations (Rᵢₙ). The generation unit 212 may calculate, with regard to the vehicle speed (V) at every 3 seconds, an average value (Vₐᵥ), a maximum value (Vₘₓ), a minimum value (Vₘₙ), and an average value of the inclinations (Vᵢₙ). The generation unit 212 may calculate, with regard to the cooling water temperature (T) at every 3 seconds, an average value (Tₐᵥ), a maximum value (Tₘₓ), a minimum value (Tₘₙ), and an average value of the inclinations (Tᵢₙ). The generation unit 212 may calculate at least one of a standard deviation, an amplitude value, a frequency, a minimum inclination, a maximum inclination, a skewness, and a kurtosis used in statistics as the feature amount of the data.

Herein, the inclination is a feature amount corresponding to a determination index indicating an extent to which the vehicle 20 is being accelerated or decelerated or indicating being in a cruise drive (constant speed drive). The inclination is a value obtained by differentiating a variation of a parameter value f(x) relative to an elapse of time (h), and is calculated by the following expression (1). In a digital arithmetic operation, the inclination is calculated by an arithmetic operation of a difference of the parameter value f(x).

$$lim \frac{f ( x + h ) - f ( x )}{h} \qquad ( 1 )$$

The output unit 213 outputs the feature amount data of the vehicle 20 and identification information of the vehicle 20 to the vehicle management server 100 via the TCU 274 as the data indicating the state of the vehicle 20.

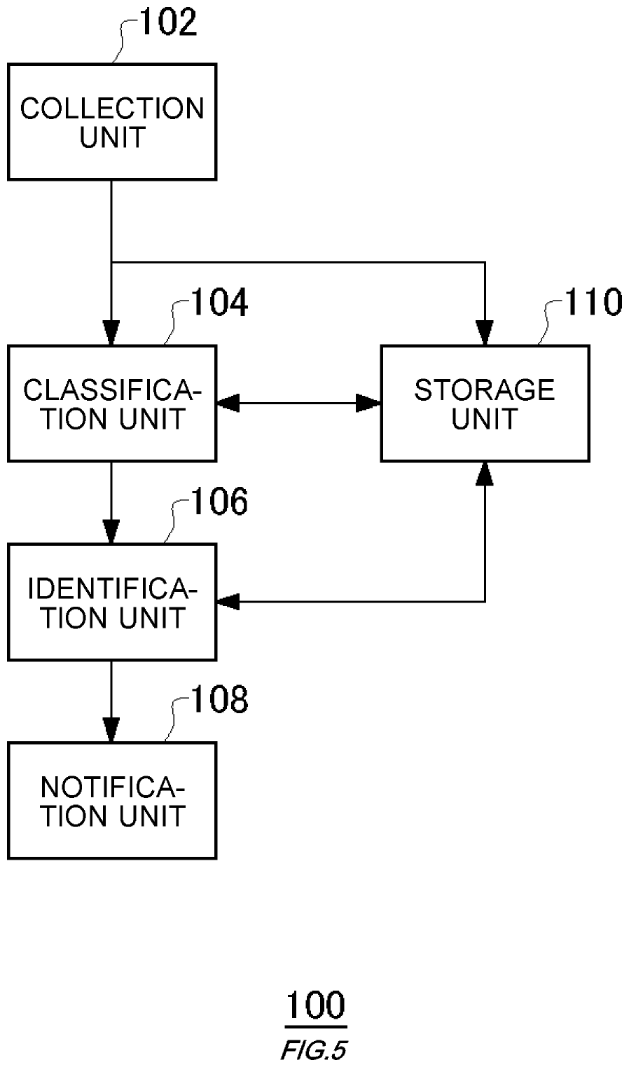

FIG. 5 illustrates one example of a functional block of the vehicle management server 100. The vehicle management server 100 includes a collection unit 102, a classification unit 104, an identification unit 106, a notification unit 108, and a storage unit 110.

The collection unit 102 collects the data indicating the state of the vehicle 20 based on the detection results of the various types of sensors 250 configured to detect the state of the vehicle from a plurality of vehicles, and stores the data in the storage unit 110 in association with the identification information of the vehicles 20. The collection unit 102 may collect, from each of the plurality of the vehicles 20, the data indicating the state of the vehicle 20 continuously acquired from the various types of sensors 250 while a driving function of the vehicle 20 is operating. The collection unit 102 may collect, from each of the plurality of the vehicles 20, the data indicating the state of the vehicle 20 continuously acquired from the various types of sensors 250 during a period from a time when an ignition switch is turned on until a time when the ignition switch is turned off. The collection unit 102 may collect, from each of the plurality of the vehicles 20, the data indicating the state of the vehicle 20 acquired from the various types of sensors 250 at a predetermined timing at which a symptom of occurrence of a failure is easily sensed while the driving function of the vehicle 20 is operating. The collection unit 102 may collect, from each of the plurality of the vehicles 20, the data indicating the state of the vehicle 20 acquired from the various types of sensors 250 while the travelling state of the vehicle 20 continues in the acceleration state, the deceleration state, or the constant speed state for a predetermined period of time (5 seconds) or longer and also the driving function of the vehicle 20 is operating.

The data indicating the state of the vehicle 20 may be data indicating the detection results of the various types of sensors 250. The data indicating the state of the vehicle 20 may be time series data indicating the detection results of the various types of sensors 250 in time series. The data indicating the state of the vehicle 20 may be a numeric vector indicating the feature amount of each of the plurality of pieces of data. The data indicating the state of the vehicle 20 may be data indicating at least one of the torque or the rotation speed of the engine or the motor generator, the temperature of the engine oil, the hydraulic pressure of the engine oil, the temperature of the hydraulic oil of the automatic transmission, the accelerator opening, and the vibration of the vehicle. The collection unit 102 may further collect data related to an environment where the vehicle 20 is present from the plurality of the vehicles 20, and store the data in the storage unit 215 in association with the data indicating the state of the vehicle 20. The data related to the environment where the vehicle 20 is present may be data indicating at least one of an outside air temperature in a surrounding of the vehicle 20 and an area (such as a latitude, a longitude, and an altitude) where the vehicle 20 is present.

The classification unit 104 classifies the plurality of vehicles 20 into a plurality of clusters (groups) according to a predetermined algorithm based on the data indicating the state of the vehicle 20 with regard to each of the plurality of the vehicles 20. The classification unit 104 may classify the plurality of vehicles 20 into the plurality of clusters according to the predetermined algorithm by machine learning.

The classification unit 104 may classify the plurality of vehicles 20 into the plurality of clusters according to the predetermined algorithm by machine learning by using the data of the various types of sensors 250 of a faulty vehicle as training data. The classification unit 104 may classify the plurality of vehicles 20 into the plurality of clusters according to the predetermined algorithm by machine learning by using the data of the various types of sensors 250 of a plurality of faulty vehicles having different faulty spots as training data of respectively different groups.

The classification unit 104 may classify the respective vehicles 20 into a plurality of different clusters for each faulty spot and a cluster without a symptom of a failure. The classification unit 104 can use, for example, a support vector machine (SVM) as a supervised machine learning algorithm. When the SVM is used, in a case where points using a pair of respective values of the data (numeric vectors) from the various types of sensors 250 of the plurality of vehicles as coordinates are mapped onto a multidimensional space, the classification unit 104 may learn a hyperplane where a set of points labeled as normal vehicles and a set of points labeled as faulty vehicles are separated from each other at a maximum margin. The classification unit 104 may learn a hyperplane where a set of points labeled as normal vehicles and respective sets of points differently labeled for each type of faulty parts are separated from each other at a maximum margin.

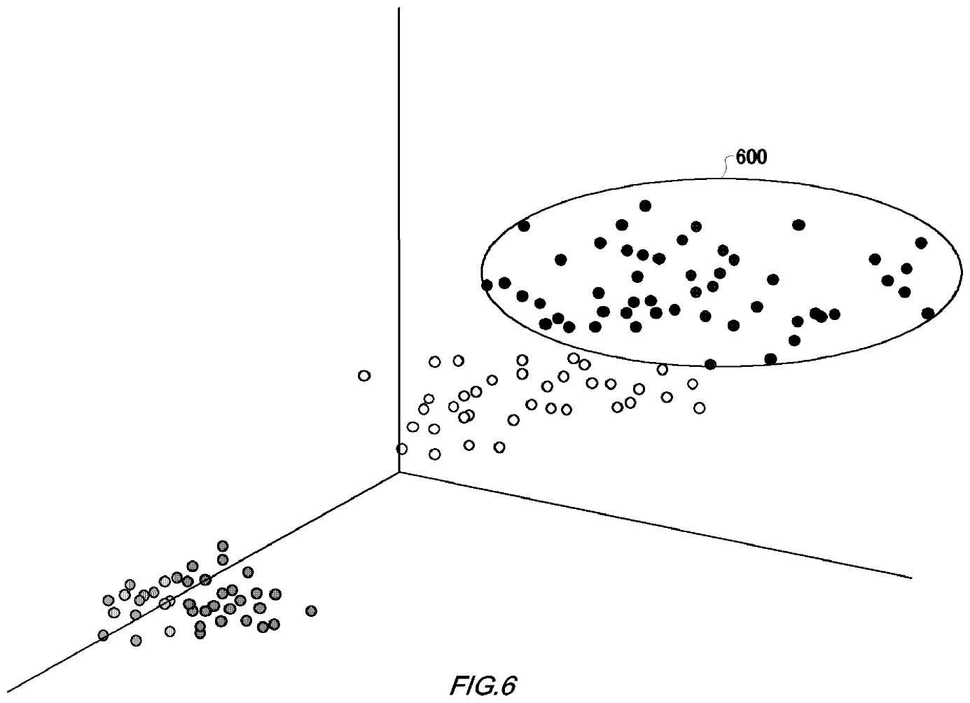

The classification unit 104 may perform a clustering processing on the plurality of numeric vectors, for example, to be classified into a plurality of clusters. The classification unit 104 may execute the clustering processing by a data analysis method of grouping data without an external criterion. That is, the classification unit 104 may execute the clustering processing of the data according to an unsupervised machine learning algorithm. A method called K-means method may be used as the clustering processing. This method is a method of plotting the data to a space of a dimension corresponding to the number of parameters, and classifying the data depending on a distance thereof. The classification unit 104 plots the data to a three-dimensional space as illustrated in FIG. 6 according to the K-means method, and classifies the plurality of vehicles 20 into a plurality of clusters. For example, the vehicles 20 corresponding to the data included in an area 600 of FIG. 6 may be classified into one cluster.

The classification unit 104 may perform clustering (primary clustering) to “20” by numeric vectors of three parameters of the engine rotation speed (R), the vehicle speed (V), and the cooling water temperature (T), for example, among the data of the various types of sensors 250. Moreover, the classification unit 104 may further perform clustering (secondary clustering) of the “20” clusters extracted by the primary clustering to “30” by all the parameters to extract “600” clusters, that is, an operation condition.

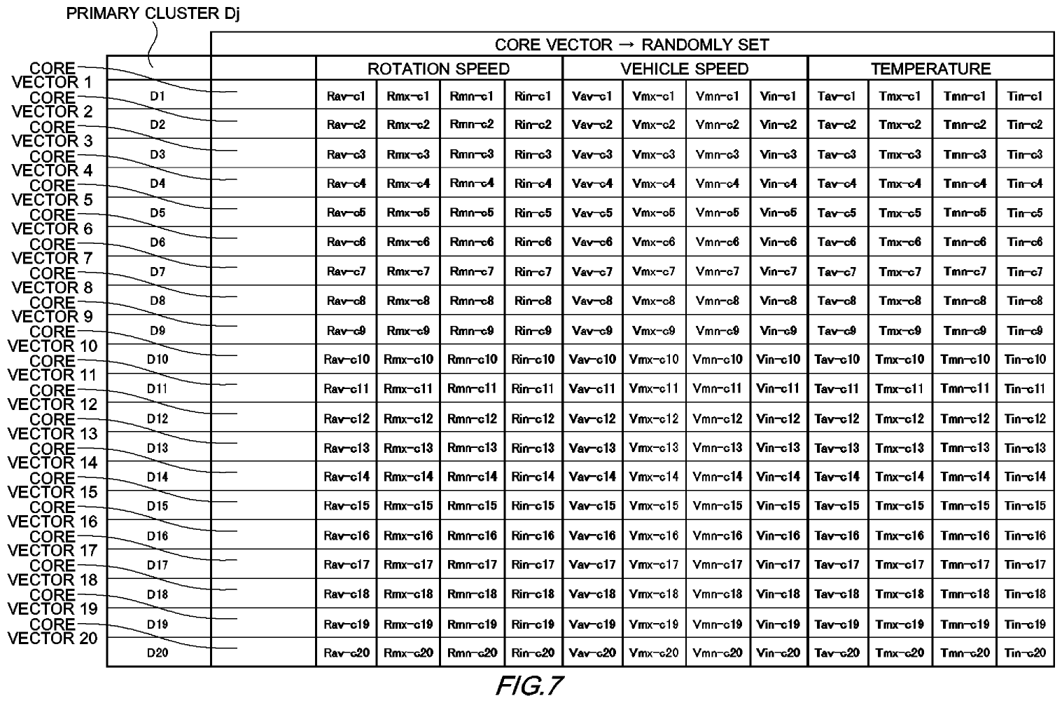

To more specific, the classification unit 104 first classifies the numeric vectors at each of time slots into 20 primary clusters Dj as illustrated in FIG. 7, for example, by the primary clustering based on a core vector. In an initial state in which the core vector is not yet set, the classification unit 104 randomly sets the core vector corresponding to a center of the 20 primary clusters. An initial value of the core vector may be set according to an empirical rule form the limited number of pieces of experimental data.

When j is set as an integer from 1 to 20, and the core vector corresponding to the center of the j-th cluster is represented by (R_{av-cj}, R_{mx-cj}, R_{mn-cj}, R_{in-cj}, V_{av-cj}, V_{mx-cj}, V_{mn-cj}, V_{in-cj}, T_{av-cj}, T_{mx-cj}, T_{mn-cj}, T_{in-cj}), a Manhattan distance D1j between the numeric vector at a first time slot (0 to 3 seconds) illustrated in FIG. 4 and the core vector of each of the 20 clusters Dj is represented by the following expression (2).

D1j=|Rₐᵥ₋₁−R_{av-cj}|═|Rₘₓ₋₁−R_{mx-cj}|+|Rₘₙ₋₁−R_{mn-cj}|+═Rᵢₙ₋₁−R_{in-cj}|+|Vₐᵥ₋₁−V_{av-cj}|+|Vₘₓ₋₁−V_{mx-cj}|+|Vₘₙ₋₁−V_{mn-cj}|+|Vᵢₙ₋₁−V_{in-cj}|+|Tₐᵥ₋₁−T_{av-cj}|+|Tₘₓ₋₁−T_{mx-cj}|+|Tₘₙ₋₁−T_{mn-cj}|+|Tᵢₙ₋₁−T_{in-cj}| (2)

With regard to one numeric vector (R, V, T) at the first time slot, the classification unit 104 calculates the Manhattan distance where the arithmetic operation of the expression (2) is performed with regard to j=1, 2, 3, . . . , 20, and sets the numeric vector (R, V, T) to belong to the cluster Dj of the core vector with the lowest value. The generation unit 212 calculates the Manhattan distance with regard to each of the numeric vectors at each time slot (3 to 6 seconds), and sets each of the numeric vectors to belong to any of the clusters Dj.

Subsequently, with regard to each of the 20 primary clusters Dj, the classification unit 104 calculates an average value of the belonging numeric vector, and sets this average value as the core vector of each cluster. The generation unit 212 executes the above described clustering again by using the updated core vector. When the core vector of each cluster is updated by the second clustering, the classification unit 104 further performs the third clustering by using the updated core vector. The classification unit 104 executes this repetition until the core vectors converge or until the previously set number of attempts ends.

A manner of the convergence may differ depending on the core vector in an initial setting. In view of the above, the classification unit 104 may randomly set, for example, 10 different initial settings, and repeat the clustering by using each of the initial settings to adopt a clustering result of the attempt with the best convergence. With this configuration, the classification unit 104 generates the eventual core vector (gravity center) with regard each of the 20 primary clusters Dj.

Subsequently, the classification unit 104 executes secondary clustering processing. In each of the 20 primary clusters Dj, the classification unit 104 further performs clustering with regard to the numeric vectors of all the parameters included in the cluster (expanding the numeric vectors of FIG. 4 to all the parameters), and classifies each of the primary clusters into 30 secondary clusters. That is, each of the 20 primary clusters corresponding to each of different operation states is divided into the 30 secondary clusters.

Since the secondary clustering is performed on each of the primary clusters to form the 30 secondary clusters, 600 (20×30) secondary clusters are obtained in total. Each of the numeric vectors belong to one of these 600 secondary clusters.

The classification unit 104 may randomly set an initial value of the core vector of the 30 secondary clusters used in the secondary clustering similarly as in the primary clustering. The classification unit 104 may set this initial value according to an empirical rule in the context of past data. The classification unit 104 may update this core vector by the same method as the primary clustering to generate the eventual core vector, and may perform eventual clustering by using the 30 eventual core vectors to generate the 600 secondary clusters.

When a faulty vehicle in which a failure has occurred is present among the plurality of vehicles 20, the identification unit 106 identifies another vehicle belonging to the cluster to which the faulty vehicle belongs from among the plurality of clusters as a failure symptom vehicle having a symptom of occurrence of a failure. The identification unit 106 may acquire identification information of the faulty vehicle and a failure content of the faulty vehicle, for example, via the terminal 310 of the dealer 300. The identification unit 106 may acquire the identification information of the faulty vehicle and the failure content of the faulty vehicle via another server configured to manage information of faulty vehicles.

For example, when the faulty vehicle belongs to the cluster of the area 600 illustrated in FIG. 6, the identification unit 106 may identify all the other vehicles 20 belonging to the cluster of the area 600 as the failure symptom vehicle having a symptom of occurrence of a failure.

The notification unit 108 notifies a notification destination associated with the failure symptom vehicle that the symptom of occurrence of the failure is present. The notification unit 108 may notify the notification destination associated with the failure symptom vehicle that the symptom of occurrence of the failure is present by a text or voice message. The notification unit 108 may notify a predetermined notification destination associated with the failure symptom vehicle of a message indicating that the symptom of occurrence of the failure is present. The predetermined notification destination may be the failure symptom vehicle or the dealer 300 where the failure symptom vehicle has been sold. The notification unit 108 may notify the user that a failure of the vehicle may occur by displaying the message indicating that the symptom of occurrence of the failure is present on a display such as the MID 271. The notification unit 108 may perform the notification of the message indicating that the symptom of occurrence of the failure is present by transmitting, to the terminal 310 of the dealer 300, a message indicating a faulty spot of the faulty vehicle and the failure symptom vehicle in which a failure at the same spot as the faulty vehicle may occur. The storage unit 110 may store an address at a notification destination of the message of each of the plurality of vehicles 20 and the plurality of dealers 300 together with each of the identification information. The notification unit 108 may refer to the storage unit 110, and identify the notification destination of the message of the failure symptom vehicle and the dealer 300 of the failure symptom vehicle.

The notification unit 108 may notify the failure symptom vehicle of a message indicating whether to repair the faulty spot or inquiring whether to request the dealer 300 to purchase a new vehicle in addition to the message indicating that the symptom of occurrence of the failure is present. When the user replies to repair the faulty spot or to request the dealer 300 to purchase the new vehicle, the output unit 213 of the vehicle 20 may notify the terminal 310 of the dealer 300 that the user has an intent to repair the faulty spot or to purchase the new vehicle. The dealer 300 places an order of a part required to repair the faulty spot, for example, to the inventory management center 400. When there is a stock of the part required to repair the faulty spot, the inventory management center 400 delivers the part to the dealer 300. When there is no stock of the part required to repair the faulty spot, the inventory management center 400 places an order to the factory 500 for fabrication of the part.

According to the present embodiment, the vehicle 20 exhibiting the same behavior as the faulty vehicle 20 is identified as the failure symptom vehicle, and the user of the failure symptom vehicle or the dealer 300 where the failure symptom vehicle is managed is notified of that effect. With this configuration, procurement of the part, delivery of the new vehicle, or the like can be progressed before the failure. Thus, it is possible to avoid a situation where the failure of the vehicle 20 occurs, and the user cannot utilize the vehicle 20.

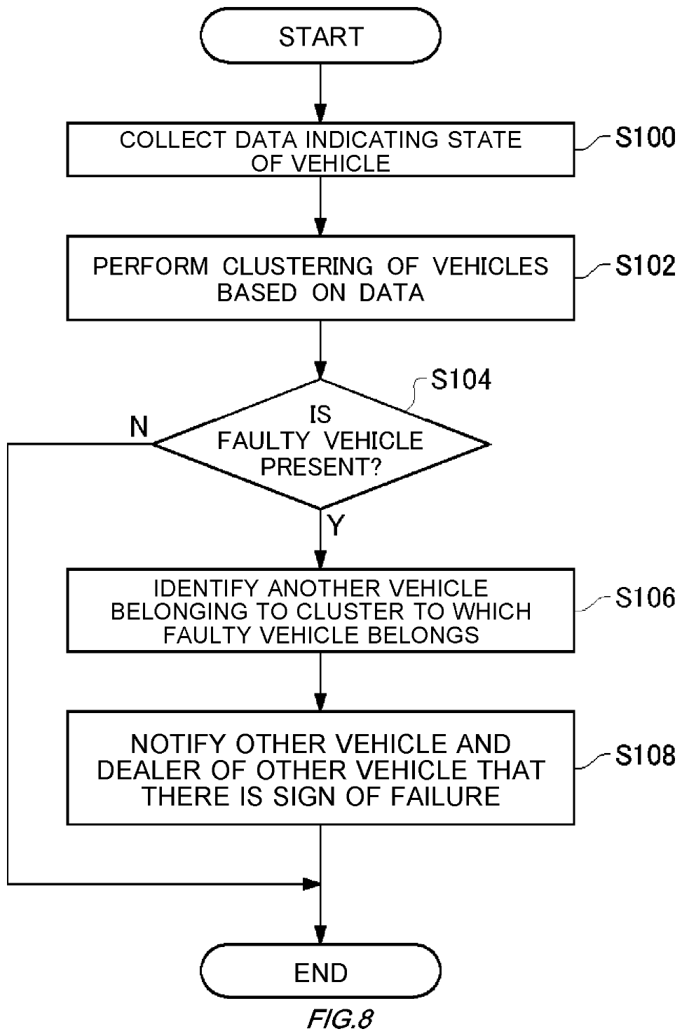

FIG. 8 is a flowchart illustrating one example of a failure symptom sensing procedure. The collection unit 102 collects data indicating a state of the vehicle 20 from each of the plurality of vehicles 20, and stores the data in the storage unit 110 (S100). The classification unit 104 classifies the plurality of vehicles 20 into a plurality of clusters according to a predetermined algorithm based on the data indicating the state of the vehicle 20 with regard to each of the plurality of the vehicles 20 (S102).

The identification unit 106 judges whether the faulty vehicle is present (S104). The identification unit 106 may access a database that stores a failure content of the faulty vehicle in association with the identification information of the faulty vehicle, and judge whether the faulty vehicle is present.

When the faulty vehicle is present, the identification unit 106 identifies another vehicle belonging to the cluster to which the faulty vehicle belongs from among the plurality of clusters as the failure symptom vehicle having a symptom of occurrence of a failure (S106). The notification unit 108 notifies the identified other vehicle and a dealer of the other vehicle that a symptom of the failure in the above described vehicle is present by way of a message (S108).

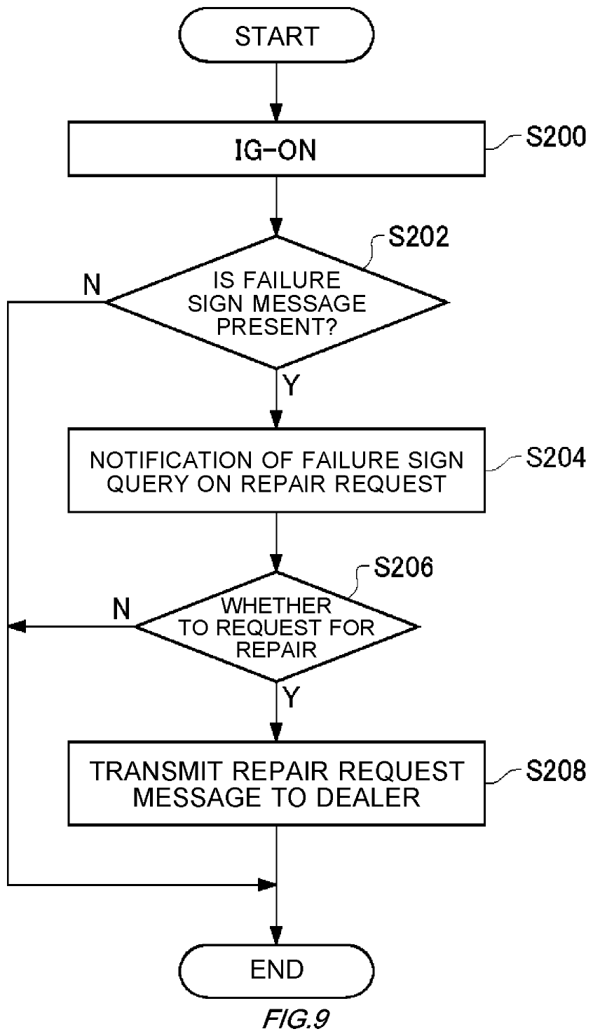

FIG. 9 is a flowchart illustrating one example of an operation procedure of the vehicle 20 when the ignition switch is turned on.

When the ignition switch is turned on (S200), the HVECU 210 judges whether a failure symptom message is received from the vehicle management server 100 (S202).

When the failure symptom message is received from the vehicle management server 100, the HVECU 210 displays a message indicating that a symptom of the failure is present or inquiring whether to request for repair of the failure symptom spot on a display such as the MID 271 (S204).

When a request to repair the failure symptom spot is received from the user (S206), for the dealer 300, the HVECU 210 transmits a repair request message of the failure symptom spot to the terminal 310 of the dealer 300 via the TCU 274 (S208). When the part required to repair the failure symptom spot is not present as a stock, the dealer 300 places an order of the part via the inventory management center 400.

As described above, according to the present embodiment, the user of the vehicle 20 exhibiting the same behavior as the faulty vehicle 20 or the dealer 300 where the vehicle is managed is notified that a symptom of the failure is present before the failure of the vehicle occurs. With this configuration, the procurement of the part, the delivery of the new vehicle, or the like can be progressed before the failure. Thus, it is possible to avoid a situation where the failure of the vehicle 20 occurs, and the user cannot utilize the vehicle 20.

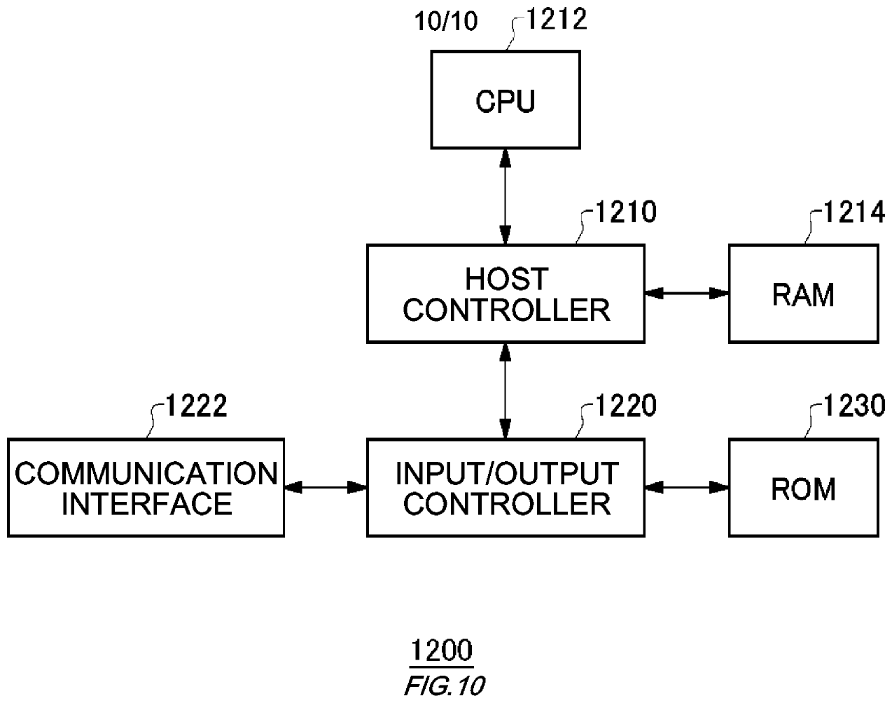

FIG. 10 illustrates one example of a computer 1200 where a plurality of embodiments of the present invention may be entirely or partially embodied. Programs installed in the computer 1200 can cause the computer 1200 to function as operations associated with the apparatus according to the embodiments of the present invention or one or more “units” of the apparatuses. Alternatively, the programs can cause the computer 1200 to execute the operations or the one or more “units”. The programs can cause the computer 1200 to execute a process according to the embodiments of the present invention or steps of the process. Such programs may be executed by a central processing unit (CPU) 1212 in order to cause the computer 1200 to execute a specific operation associated with some or all of the blocks in the flowcharts and the block diagram described in the present specification.

The computer 1200 according to the present embodiment includes the CPU 1212 and a RAM 1214, which are mutually connected by a host controller 1210. The computer 1200 also includes a communication interface 1222 and an input/output unit, which are connected to the host controller 1210 via an input/output controller 1220. The computer 1200 also includes a ROM 1230. The CPU 1212 operates according to the programs stored in the ROM 1230 and the RAM 1214, thereby controlling each unit.

The communication interface 1222 communicates with other electronic devices via a network. A hard disk drive may store the programs and data used by the CPU 1212 in the computer 1200. The ROM 1230 stores therein boot programs or the like executed by the computer 1200 at the time of activation, and/or stores programs depending on hardware of the computer 1200. The programs are provided via a computer readable recording medium such as a CD-ROM, a USB memory, or an IC card, or a network. The programs are installed in the RAM 1214 or the ROM 1230 which is also an example of the computer readable recording medium, and executed by the CPU 1212. Information processing written in these programs is read by the computer 1200, and provides cooperation between the programs and the various types of hardware resources described above. An apparatus or a method may be configured by implementing operations or processing of information according to a use of the computer 1200.

For example, when communication is performed between the computer 1200 and an external device, the CPU 1212 may execute a communication program loaded in the RAM 1214, and instruct the communication interface 1222 to execute communication processing based on processing written in the communication program. The communication interface 1222, under the control of the CPU 1212, reads transmission data stored in a transmission buffer region provided in a recording medium such as the RAM 1214 or the USB memory, transmits the read transmission data to the network, or writes reception data received from the network to a reception buffer region or the like provided on the recording medium.

In addition, the CPU 1212 may cause all or necessary portion of a file or a database stored in an external recording medium such as a USB memory, to be read by the RAM 1214, and execute various types of processing on the data on the RAM 1214. Next, the CPU 1212 may write back the processed data to the external recording medium.

Various types of programs and various types of information such as data, a table, and a database may be stored in the recording medium, and subjected to information processing. The CPU 1212 may execute, on the data read from the RAM 1214, various types of processing including various types of operations, information processing, conditional judgement, conditional branching, unconditional branching, information retrieval/replacement, or the like described in any part in the present disclosure and specified by instruction sequences of the programs, and writes back the results to the RAM 1214. In addition, the CPU 1212 may retrieve information in a file, a database, or the like in the recording medium. For example, when a plurality of entries each having an attribute value of a first attribute associated with an attribute value of a second attribute are stored in the recording medium, the CPU 1212 may retrieve, out of the plurality of entries, an entry with the attribute value of the first attribute specified that meets a condition, read the attribute value of the second attribute stored in the entry, and thereby acquire the attribute value of the second attribute associated with the first attribute meeting a predetermined condition.

The programs or software module described above may be stored on the computer 1200 or in a computer readable storage medium near the computer 1200. In addition, a recording medium such as a hard disk or a RAM provided in a server system connected to a dedicated communication network or the Internet can be used as the computer readable storage medium, so that the programs are provided to the computer 1200 via the network.

Computer readable media may include any tangible device that can store instructions for execution by a suitable device. As a result, the computer readable medium having instructions stored therein includes an article of manufacture including instructions which can be executed to create means for performing operations specified in the flowcharts or block diagrams. Examples of computer readable media may include an electronic storage medium, a magnetic storage medium, an optical storage medium, an electromagnetic storage medium, a semiconductor storage medium, etc. More specific examples of computer readable media may include a floppy (registered trademark) disk, a diskette, a hard disk, a random access memory (RAM), a read only memory (ROM), an erasable programmable read only memory (EPROM or Flash memory), an electrically erasable programmable read only memory (EEPROM), a static random access memory (SRAM), a compact disc read only memory (CD-ROM), a digital versatile disk (DVD), a BLU-RAY (registered trademark) disc, a memory stick, an integrated circuit card, etc.

Computer readable instructions may include either a source code or an object code written in any combination of one or more programming languages. The source code or the object code includes a conventional procedural programming language. The conventional procedural programming language may be assembler instructions, instruction-set-architecture (ISA) instructions, machine instructions, machine dependent instructions, microcode, firmware instructions, state-setting data, or an object oriented programming language such as Smalltalk (registered trademark), JAVA (registered trademark), C++, etc., and programming languages, such as the “C” programming language or similar programming languages. Computer readable instructions may be provided to a processor of a general purpose computer, special purpose computer, or other programmable data processing device, or to programmable circuitry, locally or via a local area network (LAN), a wide area network (WAN) such as the Internet, etc. The processor or the programmable circuitry may execute the computer readable instructions in order to create means for performing operations specified in the flowcharts or block diagrams. Examples of processors include computer processors, processing units, microprocessors, digital signal processors, controllers, microcontrollers, etc.

While the present invention have been described above by way of the embodiments, the technical scope of the present invention is not limited to the above described embodiments. It is apparent to persons skilled in the art that various alterations and improvements can be added to the above described embodiments. It is also apparent from the description of the scope of the claims that modes added with such alterations or improvements can be included in the technical scope of the present invention.

The operations, procedures, steps, and stages of each process performed by an apparatus, system, program, and method shown in the claims, embodiments, or diagrams can be performed in any order as long as the order is not indicated by “prior to,” “before,” or the like and as long as the output from a previous process is not used in a later process. Even if the process flow is described using phrases such as “first” or “next” in the claims, embodiments, or diagrams, it does not necessarily mean that the process must be performed in this order.

### EXPLANATION OF REFERENCES

10 vehicle management system
20 vehicle
50 network
100 vehicle management server
102 collection unit
104 classification unit
106 identification unit
108 notification unit
110 storage unit
200 control system
210 HVECU
211 acquisition unit
212 generation unit
213 output unit
215 storage unit
230 ECU
231 MGECU
232 engine ECU
233 transmission ECU
234 battery ECU
250 sensor
251 vehicle speed sensor
252 accelerator opening sensor
253 inclination angle sensor
254 MG rotation speed sensor
255 shift position sensor
256 engine rotation speed sensor
257 throttle opening sensor
258 vibration sensor
259 AE sensor
260 oil temperature sensor
261 water temperature sensor
262 battery temperature sensor
263 battery current sensor
264 acceleration sensor
271 MID
272 IVI
273 GNSS receiver
274 TCU
300 dealer
400 inventory management center
500 factory
310,410,510 terminal
1200 computer
1210 host controller
1212 CPU
1214 RAM
1220 input/output controller
1222 communication interface
1230 ROM

What is claimed is:

1. A vehicle management apparatus comprising:
a collection unit configured to collect data indicating a state of a vehicle detected by a sensor from a plurality of vehicles;
a classification unit configured to classify the plurality of vehicles into a plurality of clusters according to a predetermined algorithm based on the data of each of the plurality of vehicles; and
an identification unit configured to identify, when a faulty vehicle in which a failure has occurred is present among the plurality of vehicles, another vehicle belonging to a cluster to which the faulty vehicle belongs as a failure symptom vehicle having a symptom of occurrence of a failure.

2. The vehicle management apparatus according to claim 1, further comprising:
a notification unit configured to notify a notification destination associated with the failure symptom vehicle that a symptom of occurrence of a failure is present.

3. The vehicle management apparatus according to claim 1, wherein
the data indicating the state of the vehicle indicates at least one of a torque or a rotation speed of an engine or a motor generator, a temperature of engine oil, a hydraulic pressure of the engine oil, a temperature of hydraulic oil of an automatic transmission, an accelerator opening, a vibration of the vehicle, and a speed of the vehicle.

4. The vehicle management apparatus according to claim 2, wherein
the data indicating the state of the vehicle indicates at least one of a torque or a rotation speed of an engine or a motor generator, a temperature of engine oil, a hydraulic pressure of the engine oil, a temperature of hydraulic oil of an automatic transmission, an accelerator opening, a vibration of the vehicle, and a speed of the vehicle.

5. The vehicle management apparatus according to claim 1, wherein
the collection unit is configured to collect data related to an environment where the vehicle is present from the plurality of vehicles, and
the classification unit is configured to classify the plurality of vehicles into the plurality of clusters based on the data related to the environment where the vehicle is present.

6. The vehicle management apparatus according to claim 2, wherein
the collection unit is configured to collect data related to an environment where the vehicle is present from the plurality of vehicles, and
the classification unit is configured to classify the plurality of vehicles into the plurality of clusters based on the data related to the environment where the vehicle is present.

7. The vehicle management apparatus according to claim 3, wherein
the collection unit is configured to collect data related to an environment where the vehicle is present from the plurality of vehicles, and
the classification unit is configured to classify the plurality of vehicles into the plurality of clusters based on the data related to the environment where the vehicle is present.

8. The vehicle management apparatus according to claim 5, wherein
the data related to the environment where the vehicle is present indicates at least one of an outside air temperature in a surrounding of the vehicle and an area where the vehicle is present.

9. A vehicle management method comprising:
collecting data indicating a state of a vehicle detected by a sensor from a plurality of vehicles;
classifying the plurality of vehicles into a plurality of clusters according to a predetermined algorithm based on the data of each of the plurality of vehicles; and
identifying, when a faulty vehicle in which a failure has occurred is present among the plurality of vehicles, another vehicle belonging to a cluster to which the faulty vehicle belongs from among the plurality of clusters as a failure symptom vehicle having a symptom of occurrence of a failure.

10. A computer readable recording medium having recorded thereon a program for causing a computer to execute:
collecting data indicating a state of a vehicle detected by a sensor from a plurality of vehicles;
classifying the plurality of vehicles into a plurality of clusters according to a predetermined algorithm based on the data of each of the plurality of vehicles; and
identifying, when a faulty vehicle in which a failure has occurred is present among the plurality of vehicles, another vehicle belonging to a cluster to which the faulty vehicle belongs as a failure symptom vehicle having a symptom of occurrence of a failure.
